(19) United States
(12) Patent Application Publication
(10) Pub. No.: US 2024/0303670 A1
(43) Pub. Date: Sep. 12, 2024

(54) AUTOMATED CARBON MODEL MANAGEMENT METHOD AND SYSTEM

(71) Applicant: Winston L. MORTON, Porters Lake (CA)

(72) Inventor: Winston L. MORTON, Porters Lake (CA)

(73) Assignee: Climatve Inc., (US)

(21) Appl. No.: 18/312,669

(22) Filed: May 5, 2023

Related U.S. Application Data
(63) Continuation-in-part of application No. 18/179,334, filed on Mar. 6, 2023, now abandoned.
(60) Provisional application No. 63/492,761, filed on Mar. 28, 2023.

(51) Int. Cl. G06Q 30/018; G06Q 50/16

(52) U.S. Cl. CPC G06Q 30/018; G06Q 50/16

(57) ABSTRACT

An automated carbon model management system that tracks and maintains carbon scores and energy data resulting from an energy audit of a building. Carbon scores and energy data are provided by, and shareable with, users of the system. The system authenticates and validates users, keeping carbon models reliable and secure. Automated carbon models are updateable, and the system keeps a record of all data submitted to the system enabling auditability of the automated carbon models. The automated carbon model management system also provides a confidence score of the source of the carbon score indicating the trustworthiness of the carbon score.

### RELATED APPLICATIONS

This application claims the benefit under 35 U.S.C. § 119(e) to U.S. Provisional Application Ser. No. 63/492,761, titled “Automated Carbon Model Management System with Multi-Level User Authentication and Validation”, filed on Mar. 28, 2023, and U.S. application Ser. No. 18/179,334, titled “Auditable Building Ledger Method and System”, filed on Mar. 6, 2023, which is herein incorporated by reference in its entirety.

### BACKGROUND

As global efforts to combat climate change intensify, tracking and reducing carbon emissions have become increasingly important.

### SUMMARY

According to an embodiment there is provided a computer-implemented method of providing automated carbon model management, the method comprising at least a processor performing the steps of, receiving first carbon-related data including first carbon score data indicative of a first carbon score and first energy data associated with a first building from a first user, and based on authentication and validation of the first user, storing the first carbon-related data in association with the first building in a first datastore, and storing first user ID data indicative of the first user ID in association with the first carbon-related data in the first datastore. The first datastore may be one of a centralized database, cloud database, distributed database or distributed ledger. The method may also provide registering the first user as a valid user and storing associated user ID data, role data, permission data and building ID data in a user datastore.

According to another embodiment, the method provides the first carbon-related data including first source data, first source data indicative of the source of the first carbon score data, and/or first building-related data associated with the first building. According to an embodiment, receiving first carbon-related data may include converting the first carbon-related data into a predefined format for storing first carbon-related data in the first datastore in the predefined format, and/or transforming the first carbon-related data for storing the first carbon-related data in the first datastore. According to an embodiment, the method includes determining a first confidence score indicative of a first confidence level of the first carbon score based on the source data.

According to an embodiment, the method includes receiving a request from the first user for storing first carbon-related data in the first datastore, wherein the first user may include one of a person and an application programming interface. According to an embodiment, the method further includes based on the authentication and validation of the first user, storing first date data indicative of a date the first carbon-related data is stored in the first datastore.

According to another embodiment, the method also provides authenticating and validating a second user, receiving a request from the second user to store second carbon-related data related to the first building in the first datastore, receiving second carbon-related data from the second user including second carbon score data indicative of a second carbon score and second energy data associated with the first building, and based on authentication and validation of the first user, storing the first carbon-related data in a second datastore in association with the first building, the second datastore for storing audit data, removing the first carbon-related data in the first datastore in association with the first building, storing the second carbon-related data in the first datastore in association with the first building, and storing second user ID data indicative of the second user ID in association with the second carbon-related data in the first datastore. The method may also provide determining a second confidence score indicative of a second confidence level of the second carbon score based on source data and storing second confidence score data in association with the second carbon-related data in the first datastore. The method may also provide authenticating and validating a third user, receiving a request from the third user for viewing data corresponding to the first building, based on authentication and validation of the third user, transmitting data stored in the first datastore corresponding to the first building to the third user. The method may also provide authenticating and validating a fourth user, receiving a request from the fourth user for viewing audit data corresponding to the first building, and based on authentication and validation of the fourth user, transmitting data stored in the second datastore corresponding to the first building to the fourth user.

According to an embodiment there is provided computer-implemented method of providing automated carbon model management, the method comprising at least a processor performing the steps of, receiving first carbon-related data including first carbon score data indicative of a first carbon score and first energy data associated with a first building from a first user includes, receiving a plurality of first carbon-related data including a plurality of first carbon score data indicative of a plurality of first carbon scores and a plurality of first energy data associated with each of a plurality of first buildings from a first user, and based on first permissions of the first user, storing the first carbon-related data in association with the first building in a first datastore includes, storing the plurality of first carbon-related data in association with the plurality of first buildings, and storing first user ID data indicative of the first user ID in association with the first carbon-related data in the first datastore includes, storing first user ID data indicative of the first user ID in association with the plurality of first carbon-related data in the first datastore.

According to an embodiment there is provided a system configured to receive first carbon-related data including first carbon score data indicative of a first carbon score and first energy score associated with a first building from a first user, and provided the first user is authenticated and validated, store the first carbon-related data in association with the first building in a first datastore, and store first user ID data indicative of the first user ID in association with the first carbon-related data in the first datastore. In some embodiments the system is further configured to authenticate and validate a second user, receive a request from the second user to store second carbon-related data related to the first building in the first datastore, receive second carbon-related data from the second user including second carbon score data indicative of a second carbon score and second energy data associated with the first building, and provided the second user is authenticated and validated, store the first carbon-related data in a second datastore in association with the first building, the second datastore for storing audit data, remove the first carbon-related data in the first datastore in association with the first building, store the second carbon-related data in the first datastore in association with the first building, and store second user ID data indicative of the second user ID in association with the second carbon-related data in the first datastore. The system may also be configured to authenticate and validate a second user, receive a request from the second user to store second carbon-related data related to the first building in the first datastore, receive second carbon-related data from the second user including second carbon score data indicative of a second carbon score and second energy data associated with the first building, and provided the second user is authenticated and validated, store the first carbon-related data in a second datastore in association with the first building, the second datastore for storing audit data, remove the first carbon-related data in the first datastore in association with the first building, store the second carbon-related data in the first datastore in association with the first building, and store second user ID data indicative of the second user ID in association with the second carbon-related data in the first datastore. The system may be further configured to authenticate and validate a third user, receive a request from the third user for viewing data corresponding to the first building, provided the third user is authenticated and validated, transmit data stored in the first datastore corresponding to the first building to the third user. Finally, the system may be further configured to authenticate and validate a fourth user, receive a request from the fourth user for viewing audit data corresponding to the first building, and provided the fourth user is authenticated and validated, transmit data stored in the second datastore corresponding to the first building to the fourth user.

### BRIEF DESCRIPTION OF FIGURES

Embodiments of the invention are now described by way of non-limiting example and are illustrated in the following figures in which like reference numbers indicate like features, and wherein:

FIG. 1 is a simplified block diagram of exemplary automated carbon model management system and networking environment in which some embodiments may operate.

FIG. 2 is a functional block diagram of an automated carbon model management system according to an embodiment.

FIG. 3 is a flowchart of a method for managing automated carbon models according to an embodiment.

FIG. 4 shows an exemplary user database.

FIG. 5A shows an exemplary carbon model database.

FIG. 5B shows an exemplary audit trail database.

FIG. 5C shows another exemplary carbon model database.

FIG. 6 is a flowchart of additional steps of a method for managing an automated carbon model according to an embodiment.

FIG. 7 is a flowchart of another exemplary method for managing automated carbon models.

FIG. 8 shows an exemplary carbon model database.

FIG. 9 is a flowchart of another exemplary method for managing automated carbon models.

FIG. 10 shows an exemplary audit trail database.

FIG. 11 shows an exemplary carbon model database.

### DESCRIPTION

Multiple stakeholders, such as virtual energy assessment providers, real estate professionals, building owners, certified energy auditors, financial institutions, among others, would benefit from collaboration and management of carbon-related data. Current systems lack comprehensive and auditable carbon tracking. An efficient and reliable solution to maintain and authenticate carbon scores, their sources, and user roles would benefit stakeholders in climate mitigation.

The present invention provides an automated carbon model management system and method that tracks and maintains carbon scores from various system users, such as energy assessment providers, building owners, real estate professionals, and certified energy auditors, among others. The system authenticates and validates a system user's authority to change a record and for data integrity and security. The system also provides auditability and confidence ratings based on the data source of the carbon score.

A carbon score may result from an energy audit performed on a building. Energy audits use building information, such as building age, footprint, heating and cooling sources, among other building information for predicting energy characteristics of a building. Exemplary energy characteristics include energy consumed by the building and a carbon score. Other data used for performing an energy audit and energy characteristics predicted by an energy audit will be apparent to persons skilled in the art.

There are several methods for performing energy audits of a building, ranging from virtual audits using publicly available building information, such as tax assessment data, and assumed building data, to onsite energy audits using data measured and collected in person by a professional energy advisor. Other energy audit methods will be apparent to persons skilled in the art.

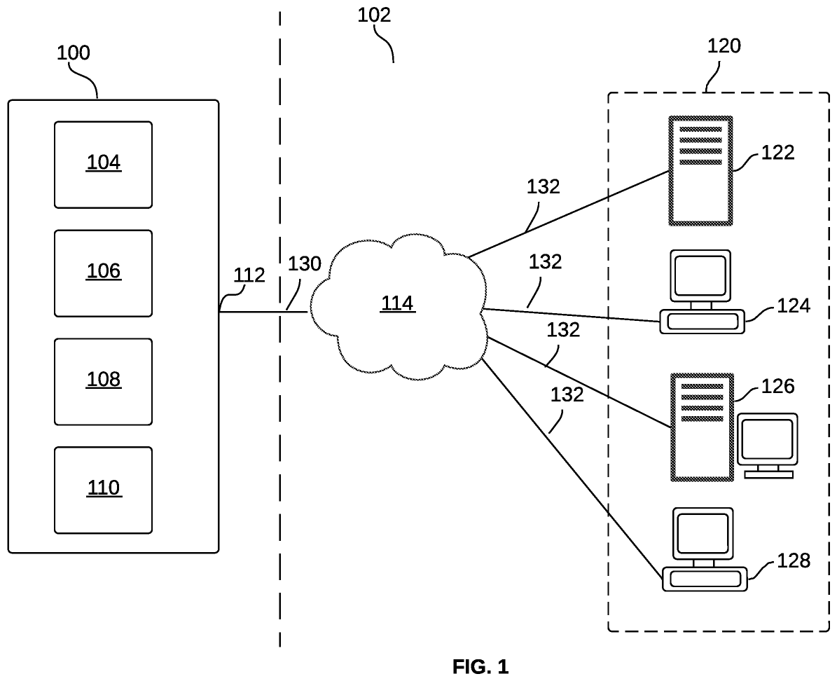

Shown in FIG. 1 is simplified block diagram of exemplary Automated Carbon Model Management System 100 (ACMMS) and networking environment 102 in which some embodiments may operate. ACMMS 100 includes processing resource 104 and datastore 106. Optionally, ACMMS 100 includes datastore 108 and further optionally includes datastore 110. ACMMS 100 also includes network interface 112 communicably coupled with a communication network, such as communication network 114, for example, the Internet, via communication link 130. Shown in networking environment 102 are remote devices 120, including devices 122, 124, 126 and 128, communicably coupled with communication network 114, via communication links 132, as shown. ACMMS 100 is configured to communicate with remote devices 120 via communication network 114.

Communication network 114 may include one or more computing systems and may be any suitable combination of networks or portions thereof to facilitate communication between network components. Some examples of networks include, Wide Area Networks (WANs), Local Area Networks (LANs), Wireless Wide Area Networks (WWANs), data networks, cellular networks, voice networks, among other networks, which may be wired and/or wireless. Communication network 114 may operate according to one or more communication protocols, such as, General Packet Radio Service (GPRS), Universal Mobile Telecommunications Service (UMTS), GSM, Enhanced Data Rates for GSM Evolution (EDGE), LTE, CDMA, 5G New Radio (NR), LPWAN, Wi-Fi, Bluetooth, Ethernet, HTTP/S, TCP, and CoAP/DTLS, or other suitable protocol. Communication network 114 may take other forms as well.

ACMMS 100 may comprise another network interface for communicatively coupling to another communication network. ACMMS 100 may comprise a plurality of servers, datastores, and other devices, configured in a centralized, distributed, or other arrangement, arranged to carry out various operations described herein. Optionally, two or more of these components may be integrated together in whole or in part.

Processing resource 104 may include one or more processors and/or controllers, which may take the form of a general or a special purpose processor or controller. In exemplary implementations, processing resource 104 may be, or include, microprocessors, microcontrollers, application specific integrated circuits, digital signal processors, and/or other data processing devices. Processing resource 104 may be a single device or distributed over a network. Processing resource 104 may be configured to store, access, and execute computer-readable program instructions stored in a datastore, to perform the operations of ACMMS 100 described herein.

Datastores 106, 108 and 110, may be or include one or more non-transitory computer-readable storage media, such as optical, magnetic, organic, or flash memory, among other data storage devices and may take any form of computer readable storage media. Datastores 106, 108 and 110 may be a single device or may be distributed over a network.

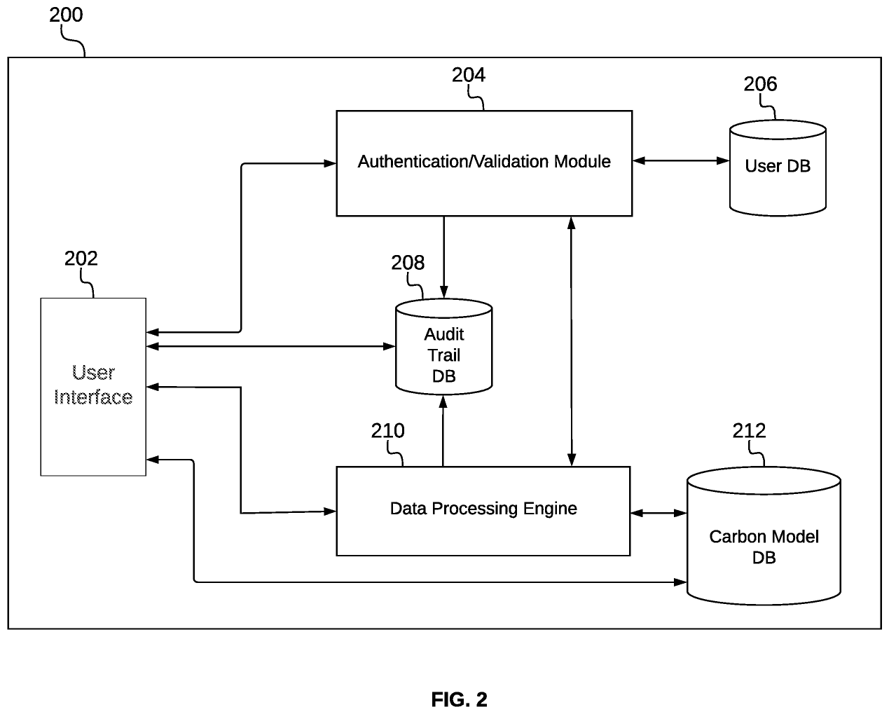

Now referring to FIG. 2, shown is a functional block diagram 200 of ACMMS 100.

Functional block diagram 200 shows user interface 202 in communication with authentication/validation module (A/V module) 204 and A/V module 204 in communication with user database 206, as shown. Functional block diagram 200 also shows data processing engine 210 in communication with user interface 202, A/V module 204, and carbon model database 212, as shown. Carbon model database 212 is also in communication with user interface 202. Finally, functional block diagram 200 shows audit trail database 208 in communication with A/V module 204, data processing engine 210 and user interface 202, as shown.

The user interface 202 communicates with users of ACMMS 100. Exemplary users include a person and an application programming interface (API).

A/V module 204 authenticates and validates the users. For instance, A/V module 204 authenticates a user's username and password, token, and/or encrypted key pair and validates a user for viewing and/or storing data in ACMMS 100. Other methods for authenticating a user will be apparent to persons skilled in the art. Validation includes comparing a user's viewing and storing permissions against their request to view data and/or store data. If a user is authenticated and validated, A/V module 204 communicates user information to data processing engine 210, and indicates the user has the right to view and/or store data in ACMMS 100.

User database 206 stores user information, such as username, password, public/private keys, role, permissions, and building IDs. In some instances, user database 206 also includes a subset of carbon model data a user may store in the carbon model database 212. A/V module 204 searches user database 206 for authenticating and validating their request, also referred to herein as validating a user.

Carbon model database 212 stores carbon-related data, including carbon score data. Carbon score data indicates a carbon score for a building. Carbon model database 212 also stores user-related information for the user that stored the carbon-related data in carbon model database 212. For each data of building related data a source of that data is provided.

Upon receiving an indication from A/V module 204 that the user is authenticated and validated, data processing engine 210 processes the user's request. If the request from a user is to view carbon-related data corresponding to a building, data processing engine 210 fetches the requested carbon-related data from the carbon model database 212 and forwards it to user interface 202. User interface 202 transmits the carbon-related data to the user. If the request from the user is to store carbon-related data corresponding to a building, data processing engine 210 removes the presently stored carbon-related data model in database 212 and stores it in Audit Trail database 208 in association with the first building. Next, data processing engine 210 stores the latest carbon-related data in carbon model database 212.

Optionally, and/or additionally, data processing engine 210 determines a confidence score for the carbon score provided by the user and adds confidence score data indicative of the confidence score to the carbon-related data and stores it in carbon model database 212. The confidence score is based on the source of the carbon score.

Data processing engine 210 may further include adding timestamp data to carbon-related data and store it in carbon model database 212. Timestamp data indicates the date and time carbon-related data was added to the carbon model database 212.

As described hereinabove, when new carbon-related data is to be stored in carbon model database 212, data processing engine 210 stores the carbon-related data currently stored in audit trail database 208, to form audit data, and then deletes it from carbon model database 212. Next, data processing engine 212 stores the new carbon-related data in carbon model database 212. Data processing engine 210 may further include timestamp data to audit data and store it in audit trail database 208. Timestamp data indicates the date and time the carbon-related data was stored in the audit trail database 208.

Upon a request for audit data, the user is authenticated and validated by A/V module 204. Next user interface 202 fetches the requested audit data from audit trail database 208 and transmits the audit data to the user.

### Process 300

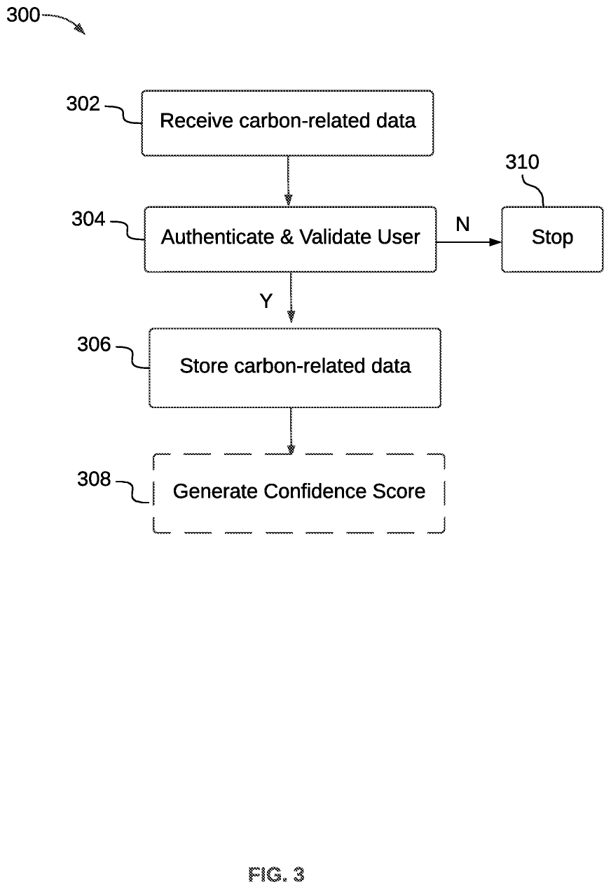

According to an embodiment there is a method for managing automated carbon models. Shown in FIG. 3 is a flowchart of a method 300 for managing automated carbon models. Method 300 is described as carried out by automated carbon model management system (ACMMS) 100 and/or functional blocks thereof shown in FIG. 2. Alternatively, process 300 may be carried out by another system, a combination of other systems, subsystems, devices or other suitable means provided the operations described herein are performed. Process 300 may be automated, semi-automated and some blocks thereof may be manually performed.

Referring to block 302, method 300 includes receiving carbon-related data corresponding to a first building from a first user. Carbon-related data includes carbon score data indicative of a carbon score and energy data. Energy data may include total energy consumed by a building, and/or energy groups, such as energy consumed by groups of elements of a home. Some examples of energy groups include, energy consumed for heating a building, energy loss from the building envelope, and energy consumed by appliances in a building. Additionally, and/or optionally, carbon-related data includes building-related data and source data indicative of the source of the carbon score data. Building-related data may include data used to perform an energy audit and energy characteristic data predicted by an energy audit.

For example, referring again to FIG. 2, user interface 202 receives a request from a first user for storing first-carbon related data corresponding to a first building BID123123. In this example, first carbon-related data includes carbon score data, energy data, building-related data and source data indicative of the source of the carbon score data. The request includes first-carbon related data.

Next, at block 304, method 300 includes authenticating and validating the first user. According to an embodiment, authenticating a first user includes confirming the first user's username and password. Alternatively, authenticating a first user includes another method for authenticating a user. Other methods for authenticating a user will be apparent to persons skilled in the art.

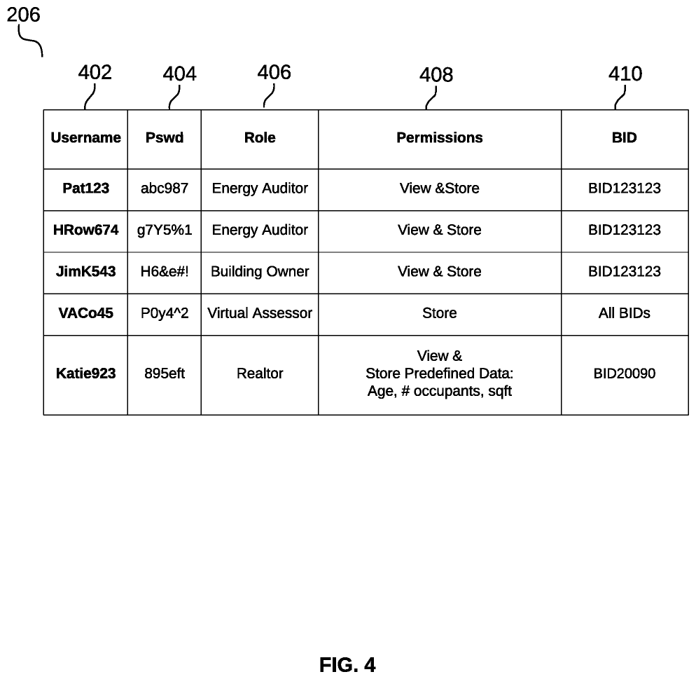

For example, user interface 202 provides A/V module 204 the username and password of the first user. In this example, the first user provides a username Pat123 and password abc987. A/V module 204 searches a user database for the username and password. An exemplary user database 400 is shown in FIG. 4.

Exemplary user database 400 includes username data 402, indicating a username of a user of ACMMS 100, password data 404, indicating a password corresponding to a username, role data 406 indicative of a role of a user, permissions data 408 indicative of the type of access a user has, (i.e., to view and/or store data), and BID data 410, indicative of the buildings a user may view and/or store corresponding data. Exemplary roles may include virtual assessor, building owner, realtor, real estate broker, energy auditor, and financial institution, among others.

A/V module 204 locates the first user's username and password in user database 400 and authenticates the first user.

Next, A/V module 204 validates the first user.

For example, user interface 202 provides the first user's request to A/V module 204. In this example, the first user's request includes storing in ACMMS 100 first carbon-related data related to building BID123123. A/V module 204 searches user database 400 for permissions assigned to the first user. For instance, the first user has permission to view data related to a building BID123123 and has permission to store data related to a building having BID123123, as shown in permission data 408 and BID data 410 of FIG. 4. As such, A/V module 204 validates the first user and sends an indication to data processing engine 210 that the first user has been authenticated and validated. Method 300 moves to block 306. However, if the first user is not authenticated and validated method 300 stops at block 310, as shown.

Next at block 306, method 300 includes storing the carbon-related data corresponding to the first building in a first datastore.

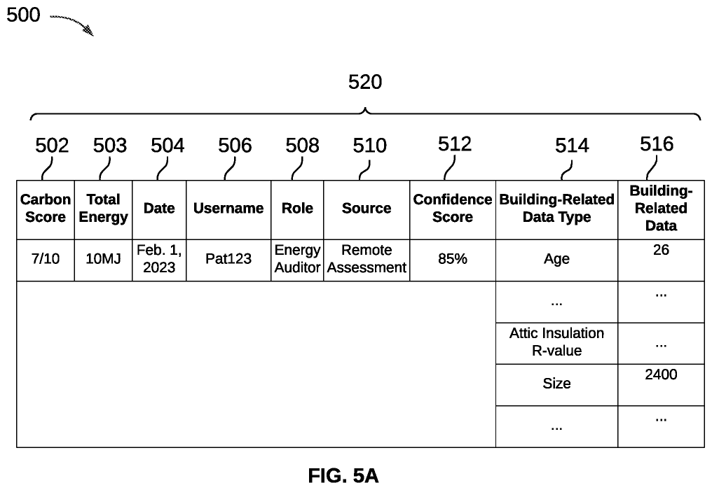

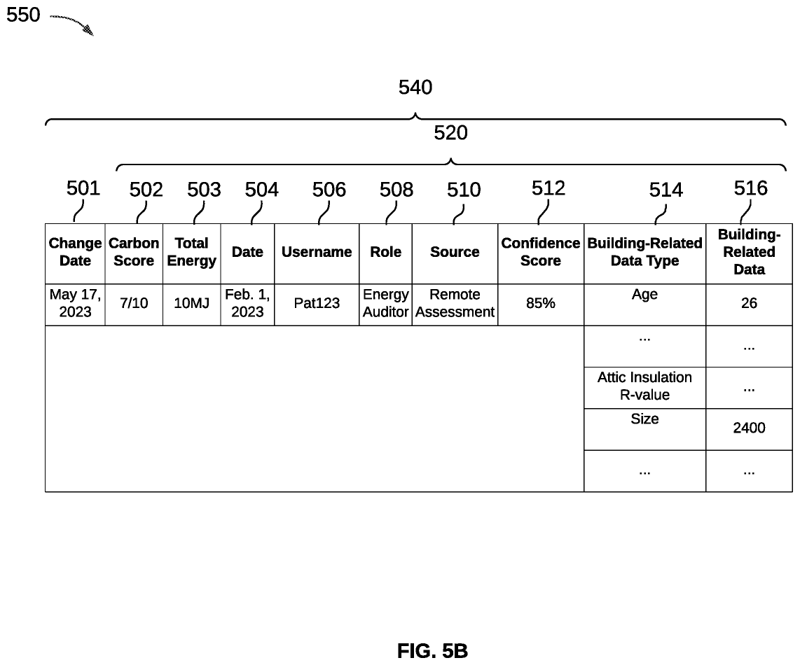

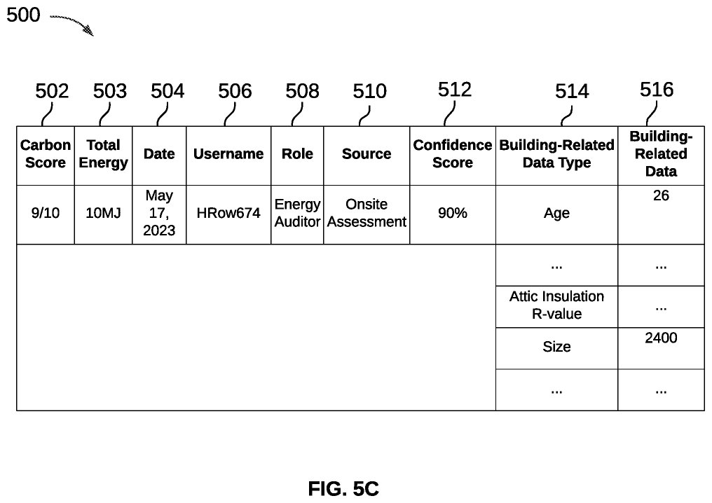

In a first example, user interface 202 provides the first carbon-related data to the data processing engine 210 and data processing engine 210 stores the first carbon-related data in the exemplary carbon model database 500, shown in FIG. 5A. Additionally, and/or optionally, data processing engine 210 also adds date data to the first carbon-related data and stores it in carbon model database 500. Further additionally, and/or optionally, data processing engine 210 adds username data to the first carbon-related data and stores it in carbon model database 500. Further additionally, and/or optionally, data processing engine 210 adds role data to the first carbon-related data and stores it in carbon model database 500. In this example, the role of the first user is Energy Auditor Assessor. Carbon model database 500 may be stored in datastore 106, shown in FIG. 1.

The first datastore is at least one of a centralized database, cloud database, distributed database, distributed ledger (e.g., blockchain), or other type of organized database. A specific and non-limiting example of a centralized database includes a database located, stored, and maintained in a single location, such as central computer. A specific and non-limiting example of a cloud database includes Microsoft Azure®. A specific and non-limiting example of a distributed database includes Amazon SimpleDB®.

Referring again to FIG. 5 is exemplary carbon model database 500 includes first carbon-related data 520 comprising carbon score data 502, energy data 503, date data 504, username data 506, role data 508, source data 510, and building-related data 516.

Carbon-related data is stored in carbon model database 212 in a predefined format. In other words, data in carbon model database 212 is organized in a specific way. As such, data processing engine 210 validates the incoming data to ensure it is in the correct format for storing it in carbon model database 212. In some instances, data processing engine 210 converts the data into the predefined format prior to storing it in carbon model database 212.

In a first example, data provided by a user is an unrecognizable format. As such, data processing engine 210 sends an indication to user interface 202 that the carbon-related data is invalid. Next, user interface 202 sends an indication to the user that the data is invalid.

In another example, received carbon-related data is not in the predefined format, yet it is in a format data processing engine 210 understands. As such, data processing engine 210 reorganizes the data into the predefined format prior to storing the data in carbon model database 500. For instance, the predefined format may be JSON. If carbon-related data is received in XML or CSV format, data processing engine 210 recognizes these formats and reorganizes the carbon-related data into JSON prior to storing the data in carbon model database 212.

Carbon-related data is also stored in carbon model database 212 in predefined measurement units. As such, data processing engine 210 may transform the data to the correct measurement units prior to storing it in carbon model database 212. For example, a user provides an energy value in kWh whereas carbon model database 212 uses GJ as the standard unit. Data processing engine 210 transforms the provided data to GJ prior to storing the carbon related data in the carbon model database 212. In another example, a user provides a metric for natural gas in m3 whereas carbon model database 212 uses GJ as the standard unit. Data processing engine 210 transforms the provided data to GJ prior to storing the carbon related data in the carbon model database 212.

In some instances, method 300 further includes block 308 wherein method 300 includes generating a confidence score indicating a confidence level of the carbon score data based the source of the carbon score.

For example, data processing engine 210 may assign a lower confidence score to a carbon score if the source of the carbon score is a virtual assessor compared to a confidence score for a carbon score wherein the source of the carbon score is from an energy advisor. A lower confidence score may be assigned to a carbon score if the source of the carbon score is a virtual assessor because a virtual assessor uses estimated data in contrast to measured data used by an energy advisor.

Once data processing engine 210 assigns a confidence score for a carbon score, confidence score data 512 is added to the carbon-related data and stored in carbon model database 500. For ease of description, building-related data type 514 is included in FIG. 5A.

### Process 600

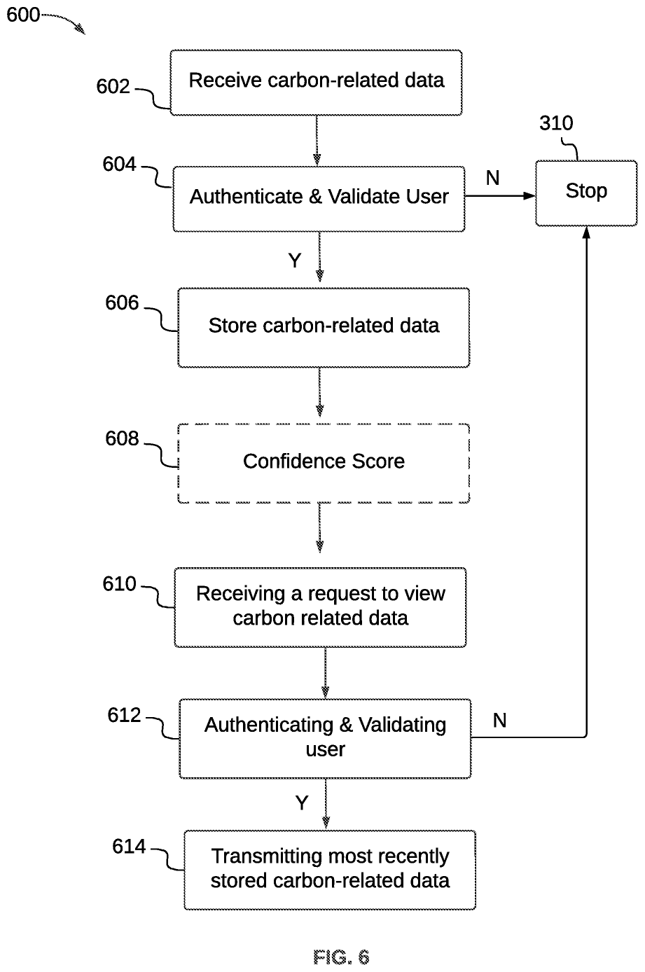

According to an embodiment, process 300, a method for managing automated carbon models, further includes process 600. A flowchart of process 600 is shown in FIG. 6.

Referring to block 602, method 600 includes receiving carbon-related data corresponding to a first building from a second user. Carbon-related data includes carbon score data indicative of a carbon score and energy data. Additionally, and/or optionally, carbon-related data includes building-related data and source data indicative of the source of the carbon score data. Building-related data may include data used to perform an energy audit and energy characteristic data predicted by an energy audit.

For example, referring again to FIG. 2, user interface 202 receives a request from a second user for storing second carbon-related data related to the building BID123123. In this example, second carbon-related data includes carbon score data, energy data, building-related data and source data indicative of the source of the carbon score.

Next, at block 604, method 600 includes authenticating and validating the second user. According to an embodiment, authenticating a first user includes confirming the second user's username and password.

For example, user interface 202 provides A/V module 204 the username and password of the second user. In this example, the second user provides a username of HRow674 and password g7Y5%1. A/V module 204 searches a user database, such as exemplary user database 206 shown in FIG. 4, for the username and password.

A/V module 204 locates the second user's username and password in user database 206 and authenticates the second user. Alternatively, authenticating a first user includes another method for authenticating a user. Other methods for authenticating a user will be apparent to persons skilled in the art.

Next, A/V module 204 validates the second user.

For example, user interface 202 provides the second user's request to A/V module 204. In this example, the second user's request includes storing in ACMMS 100 first carbon-related data related to building BID123123. A/V module 204 searches user database 206 for permissions assigned to the second user. For instance, the second user has permission to view data related to a building BID123123 and has permission to store data related to a building BID123123, as shown in permission data 408 of FIG. 4. As such, A/V module 204 validates the second user and sends an indication to data processing engine 210 that the second user has been authenticated and validated. Method 600 moves to block 606. However, if the first user is not authenticated and validated method 600 stops at block 310, as shown.

Next at block 606, method 600 includes storing the second carbon-related data corresponding to the first building in the first datastore. Method 606 further includes storing the presently stored carbon-related data in the carbon model database in the audit trail database and deleting the presently stored carbon-related data in the carbon model database.

In a first example, user interface 202 provides the second carbon-related data to the data processing engine 210. Data processing engine 210 stores carbon model 520, shown in FIG. 5A, presently stored in carbon model database 500, in audit trail database 550. Audit trail database 550 may be stored in datastore 110, shown in FIG. 1. Shown in FIG. 5B is audit trail database 550 associated with building BID123123 including exemplary audit trail data 540 including carbon model 520. In this example, data processing engine 210 includes change date data 501 in audit data 540 indicating the date carbon model 520 was stored in audit data. For example, carbon model 520 was stored in audit trail data 540 on May 17, 2023. For ease of description, building-related data type 514 is included in FIG. 5B.

Next, data processing engine 210 deletes carbon model 520 presently stored in carbon model database 500, as shown in FIG. 5C. For ease of description, building-related data type 514 is included in FIG. 5C.

Finally, data processing engine 210 stores the second carbon-related data in the carbon model database 500, as shown in FIG. 5C. Additionally, and/or optionally, data processing engine 210 also adds date data to the second carbon-related data and stores it in carbon model database 500. Further additionally, and/or optionally, data processing engine 210 adds username data to the second carbon-related data and stores it in carbon model database 500. Further additionally, and/or optionally, data processing engine 210 adds role data to the second carbon-related data and stores it in carbon model database 500. In this example the role of the second user is Energy Auditor, as shown.

Referring again to FIG. 5C, exemplary carbon model database 500 includes second carbon-related data 522 comprising carbon score data 502, energy data 503, date data 504, username data 506, role data 508, source data 510, and building-related data 516.

In some instances, method 600 further includes block 608 wherein method 600 includes generating a confidence score indicating a confidence level of the carbon score data based on the source of the carbon score.

For example, data processing engine 210 may assign a lower confidence score to a carbon score if the source of the carbon score is a virtual assessor compared to a confidence score for a carbon score wherein the source of the carbon score data is from an energy advisor A lower confidence score may be assigned to a carbon score if the source of the carbon score is a virtual assessor because a virtual assessor uses estimated data in contrast to measured data used by an energy advisor.

Once data processing engine 210 assigns a confidence score for a carbon score, confidence score data 512, 90%, is added to the carbon-related data and stored in carbon model database 500, as shown.

Next at block 610, method 600 includes receiving a request to view data relating to the first building from a third user.

For example, user interface 202 receives a request from a third user requesting to view data related to the first building BID123123.

Next, at block 612, method 300 includes authenticating and validating the third user. According to an embodiment, authenticating a third user includes confirming the third user's username and password.

For example, user interface 202 provides A/V module 204 the username and password of the third user. In this example, the third user provides a username JimK543 and password H6&e#!. A/V module 204 searches a user database for the username and password. An exemplary user database 206 is shown in FIG. 4. A/V module 204 locates the third user's username and password in user database 206 and authenticates the third user. User database 206 may be stored is datastore 108. Alternatively, authenticating a third user includes another method for authenticating a user. Other methods for authenticating a user will be apparent to persons skilled in the art.

Next, A/V module 204 validates the third user.

For example, user interface 202 provides the third user's request to A/V module 204. In this example, the third user's request includes viewing carbon-related data related to building BID123123. A/V module 204 searches user database 206 for permissions assigned to the third user. For instance, the third user has permission to view data related to a building BID123123 and has permission to store data related to a building BID123123, as shown in permission data 408 of FIG. 4. As such, A/V module 204 validates the third user and sends an indication to data processing engine 210 that the third user has been authenticated and validated. Method 600 moves to block 614. However, if the first user is not authenticated and validated method 600 stops at block 310, as shown.

Next, at block 614, method 600 includes transmitting carbon model data stored in the first datastore.

For example, user interface 202 fetches carbon model 522 from the carbon model database 212 and transmits it to the third user.

### Process 700

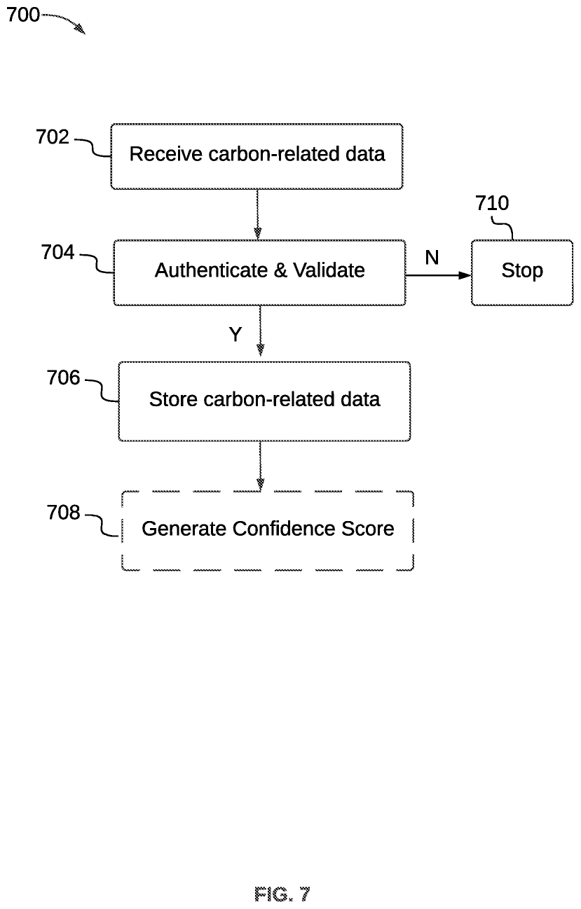

According to an embodiment there is another method for managing automated carbon models. Shown in FIG. 7 is a flowchart of process 700 for managing automated carbon models. Process 700 is described as carried out by automated carbon model management system (ACMMS) 100 and/or functional blocks thereof, shown in FIG. 2. Alternatively, process 700 may be carried out by another system, a combination of other systems, subsystems, devices or other suitable means provided the operations described herein are performed. Process 700 maybe automated, semi-automated and some blocks thereof may be manually performed.

Referring to block 702, process 700 includes receiving a plurality of third carbon-related data corresponding to a plurality of second buildings from a fourth user. The plurality of third carbon-related data includes a plurality of third carbon score data indicative of a plurality of third carbon scores and third energy data. Additionally, and/or optionally, the plurality of third carbon-related data includes a plurality of third building-related data and a plurality of third source data each indicative of the source of the corresponding carbon score data. The plurality of third building-related data may include data used to perform an energy audit and energy characteristic data predicted by an energy audit for the plurality of second buildings.

For example, referring again to FIG. 2, user interface 202 receives a request from a fourth user for storing a plurality of third-carbon related data related to a plurality of second buildings BID200000-BID210000. (i.e., ten thousand and one buildings). In this example, the plurality of third carbon-related data includes a plurality of third building-related data and a plurality of third source data indicative of the source of the corresponding third carbon scores data. The request from a fourth user includes the plurality of third carbon-related data.

Next, at block 704, method 700 includes authenticating and validating the fourth user. According to an embodiment, authenticating a fourth user includes confirming the fourth user's username and password.

In this example, the fourth user is a virtual assessment provider, also referred to herein as a virtual assessor, and communicates with user interface 202 via an application programming interface (API). The API provides its username and password, VACo45 and P0y4\hat{ }2, respectively, to user interface 202.

A/V module 204 searches a user database, such as exemplary user database 206, shown in FIG. 4, for username VAco45 and corresponding password, P0y4\hat{ }2. A/V module 204 locates the fourth user's username and password in user database 206 and authenticates the fourth user.

Alternatively, the API provides its login credentials to user interface 202 of the virtual assessment provider. A/V module authenticates the fourth user using another authentication method. Methods for authenticating a user will be apparent to persons skilled in the art.

Next, A/V module 204 validates the fourth user.

For example, user interface 202 provides the fourth user's request to A/V module 204. In this example, the fourth user's request includes storing in ACMMS 100 the plurality of third carbon-related data related to buildings BID200000-BID210000. A/V module 204 searches user database 206 for permissions assigned to the fourth user. For instance, the fourth user has permission to store data related to all buildings, as shown in permission data 408 and BID data 410 of FIG. 4. As such, A/V module 204 validates the fourth user and sends an indication to data processing engine 210 that the fourth user has been authenticated and validated. Method 700 moves to block 706. However, if the fourth user is not authenticated and validated method 700 stops at block 710, as shown.

Next at block 706, method 700 includes storing the plurality of third carbon-related data corresponding to the plurality of second buildings in a first datastore.

For example, user interface 202 provides the plurality of third carbon-related data to the data processing engine 210 and data processing engine 210 stores the plurality of third carbon-related data in the carbon model database 212. Additionally, and/or optionally, data processing engine 210 also adds date data to the plurality of third carbon-related data and stores it in carbon model database 212. Further additionally, and/or optionally data processing engine 210 adds username data to the plurality of third carbon-related data and stores it in carbon model database 212. Further additionally, and/or optionally data processing engine 210 adds role data to the plurality of third carbon-related data and stores it in carbon model database 212. In this example the role of the second user is Virtual Assessor, as shown in FIG. 4. Carbon model database 212 may be stored in datastore 106, shown in FIG. 1.

The first datastore is at least one of a centralized database, cloud database, distributed database, distributed ledger (e.g., blockchain), or other type of organized database. A specific and non-limiting example of a centralized database includes a database located, stored, and maintained in a single location, such as central computer. A specific and non-limiting example of a cloud database includes Microsoft Azure®. A specific and non-limiting example of a distributed database includes Amazon SimpleDB®.

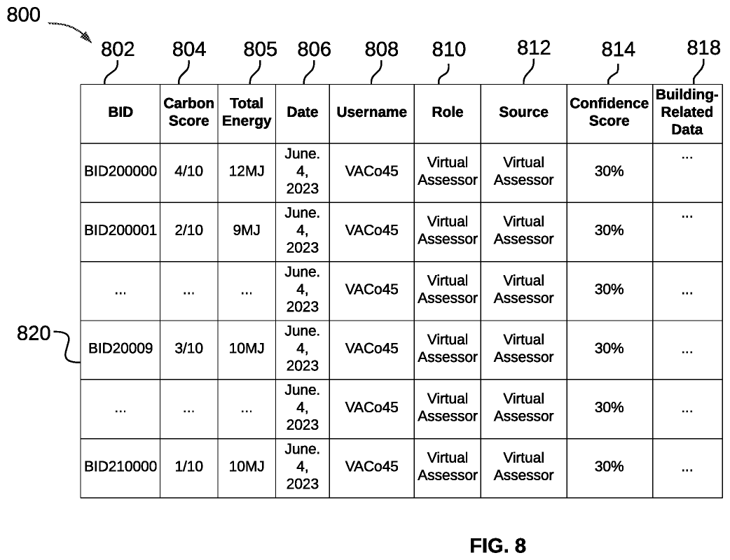

Shown in FIG. 8 is another exemplary carbon model database 800, including BID 802 corresponding to buildings BIDs BID200000-BID210000, third carbon-related data comprising building-related data 818, carbon score data 804 and energy data 805. Also shown in carbon model database 800 is date data 806 indicative of the date the plurality of third carbon-related data was stored in the carbon model database 800, username data 808 indicative of the username of the fourth user, VACo45, role 810 data indicative of the role of the fourth user, and source data 812 indicative of the source of carbon score data 804.

In some instances, method 700 further includes block 708 wherein method 700 includes generating a confidence score indicating a confidence level of the carbon score data based on the source data of the carbon score data.

For example, data processing engine 210 may assign a lower confidence score to a carbon score if the source of the carbon score is a virtual assessor compared to a confidence score for a carbon score wherein the source of the carbon score data is from an energy advisor A lower confidence score may be assigned to a carbon score if the source of the carbon score is a virtual assessor because a virtual assessor uses estimated data in contrast to measured data used by an energy advisor.

Once data processing engine 210 assigns a confidence score to a carbon score, confidence score 814, 30%, is added to the plurality of third carbon-related data and stored in carbon model database 800, as shown in FIG. 8

### Process 900

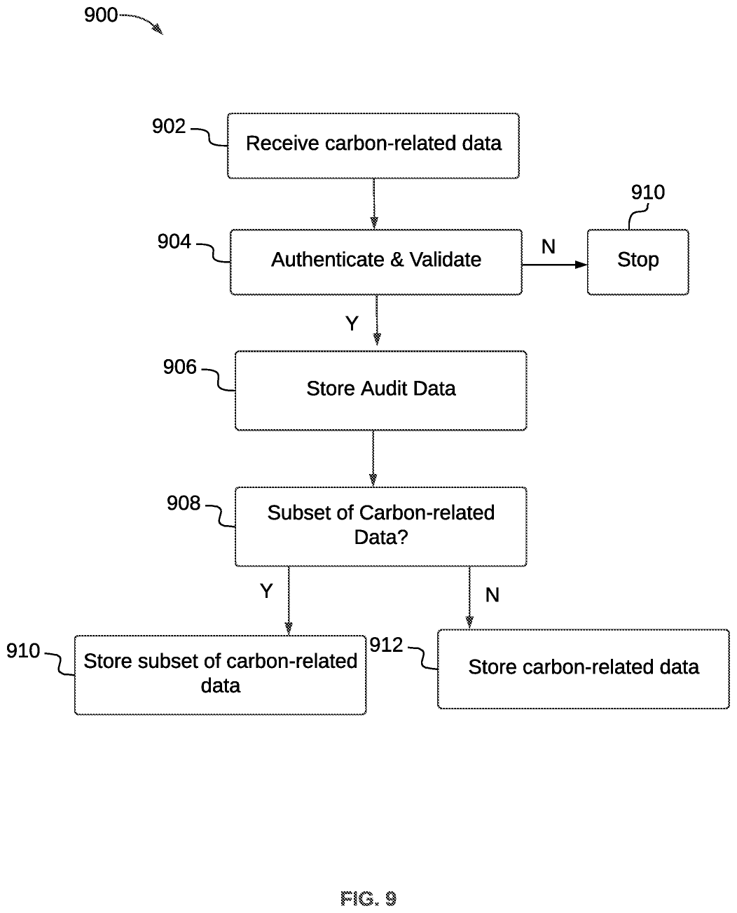

According to an embodiment there is another method for managing automated carbon models. Shown in FIG. 9 is a flowchart of a method 900 for managing automated carbon models. Method 900 is described as carried out by automated carbon model management system (ACMMS) 100 and/or functional blocks thereof, shown in FIG. 2. Alternatively, process 900 may be carried out by another system, a combination of other systems, subsystems, devices or other suitable means provided the operations described herein are performed. Process 900 may be automated, semi-automated and some blocks thereof may be manually performed.

Referring to block 902, method 900 includes receiving fourth carbon-related data corresponding to a fourth building from a fifth user. Carbon-related data may include carbon score data, energy data, building-related data and source data indicative of the source of the carbon score data. Building-related data may include data used to perform an energy audit and energy characteristic data predicted by an energy audit.

For example, referring again to FIG. 2, user interface 202 receives a request from a fifth user for storing fourth carbon related data related to a fourth building having BID BID20090. The request includes fourth carbon-related data.

Next, at block 904, method 900 includes authenticating and validating the fifth user. According to an embodiment, authenticating a fifth user includes confirming the fifth user's username and password.

For example, user interface 202 provides A/V module 204 the username and password of the fifth user. In this example, the fifth user provides a username Katie923 and password 895eft. A/V module 204 searches a user database, such as exemplary user database 206 shown in FIG. 4 for the username and password.

Exemplary user database 206 includes username data 402, indicating a username of a user of ACMMS 100, password data 404, indicating a password corresponding to a username, role data 406 indicative of a role of a user, permissions data 408 indicative of the type of access a user has, (i.e., to view and/or store data), and BIDs data 410, indicative of the buildings a user may view and/or store corresponding data

A/V module 204 locates the fifth user's username and password in user database 206 and authenticates the fifth user.

Next, A/V module 204 validates the fifth user.

For example, user interface 202 provides the fifth user's request to A/V module 204. In this example, the fifth user's request includes storing in ACMMS 100 sixth carbon-related data related to building BID20090. A/V module 204 searches user database 206 for permissions assigned to the fifth user. For instance, the fifth user has permission to view data related to a building BID20090 and has permission to store predefined carbon-related data related to building BID20090, as shown in permission data 408 and BID data 410 of FIG. 4. In this example, user Katie923 has permission to store fourth carbon related data comprising, age data, indicative of the building's age, # of occupant data, indicative of the number of occupants of the building, and square footage data indicative of the square footage of the building. Thus, user Katie923 only has permission to store a subset of fourth carbon related data and is not allowed to store any other data, such as carbon score data.

A/V module 204 validates the fifth user and sends an indication to data processing engine 210 that the fifth user has been authenticated and validated to store only age data, # of occupant data and square data footage. Method 900 moves to block 906.

At block 906, process 900 includes storing carbon-related data currently stored in carbon model database in the audit trail database.

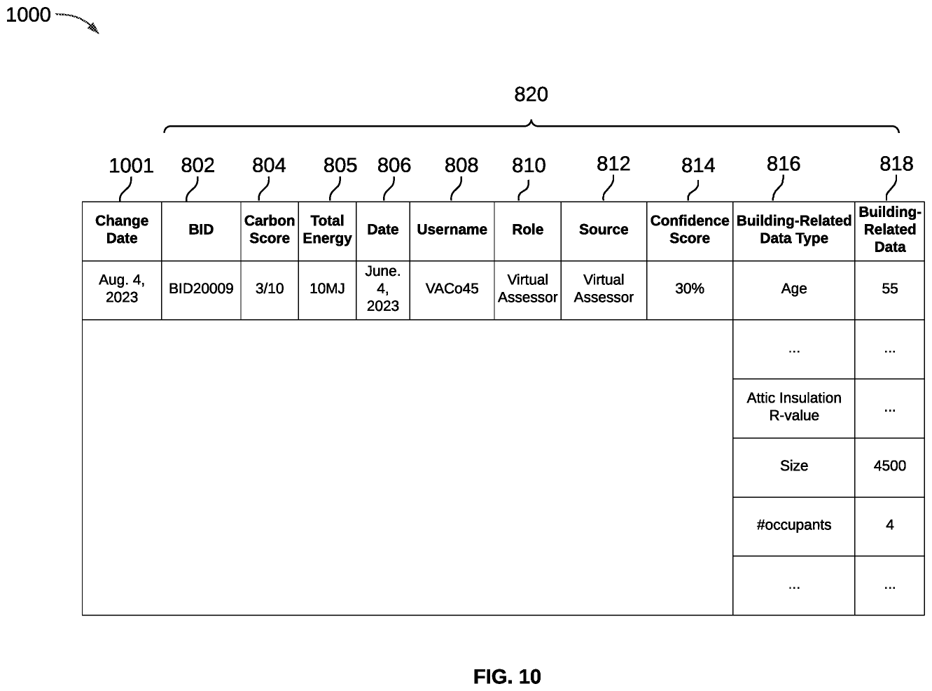

For example, data processing engine 210 stores carbon-related data 820 exemplary audit trail database 1000 is shown in FIG. 10. In this example, data processing engine 210 includes change date data 1001 in audit data 1000 indicating the date carbon model 820 was stored in audit data. For example, carbon model 820 was stored in audit trail data 540 on Aug. 4, 2023.

Next, at block 908. process 900 includes determining whether the user is able to store all carbon-related data to the first datastore or only a subset thereof.

Data processing engine 210 determines that user Katie923 only has permission to store a subset of predefined carbon-related data in the first datastore, age data, # occupants data and size data. As such, process 900 proceeds to block 910. Otherwise, process 900 proceeds to block 912.

At block 908, process 900 includes storing the subset of predefined carbon-related data to the carbon model database.

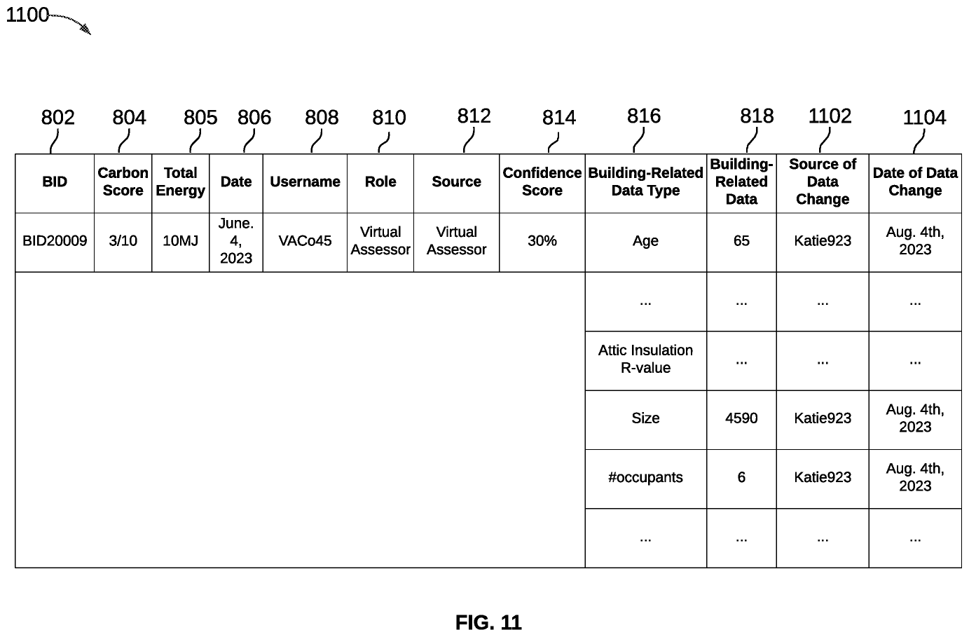

For example, data processing engine 210 stores age data, indicating the age of the building is 65 years old, size data, indicating the building is 4590 square feet, and # occupant data, indicating 6 occupants, in exemplary carbon model database 1100, shown in FIG. 11. Data processing engine 210 also includes source of data change data 1102, Katie923, in carbon-related data, and date of data change data 1104 indicating the date the subset of predefined data was stored in the carbon model database.

At block 912, process 900 includes data processing engine deleting the presently stored carbon-related data in the carbon model database corresponding to the fourth building and storing the received carbon-related data in the carbon model database.

In this example, process 900 does not proceed to block 912.

Included in the discussion above are a series of flow charts showing the steps and acts of various processes. The processing and decision blocks of the flow charts above represent steps and acts that may be included in algorithms that carry out these various processes. Algorithms derived from these processes may be implemented as software integrated with and directing the operation of one or more processors, may be implemented as functionally-equivalent circuits such as a Digital Signal Processing (DSP) circuit, a Field Programmable Gate Array (FPGA), an Application-Specific Integrated Circuit (ASIC), or may be implemented in any other suitable manner. It should be appreciated that the flow charts included herein do not depict the syntax or operation of any circuit or of any programming language or type of programming language. Rather, the flow charts illustrate the functional information one skilled in the art may use to fabricate circuits or to implement computer software algorithms to perform the processing of an apparatus carrying out the types of techniques described herein. It should also be appreciated that, unless otherwise indicated herein, the sequence of steps and/or acts described in each flow chart is merely illustrative of the algorithms that may be implemented and can be varied in implementations and embodiments of the principles described herein. Accordingly, in some embodiments, the techniques described herein may be embodied in computer-executable instructions implemented as software, including as application software, system software, firmware, middleware, embedded code, or any other suitable type of computer code. Such computer-executable instructions may be written using any of several suitable programming languages and/or programming or scripting tools and may be compiled as executable machine language code or intermediate code that is executed on a framework or virtual machine.

Computer-executable instructions implementing the techniques described herein may, in some embodiments, be encoded on one or more computer-readable media to provide functionality to the media. Computer-readable media include magnetic media such as a hard disk drive, optical media such as a Compact Disk (CD) or a Digital Versatile Disk (DVD), Blu-Ray disk, a persistent or non-persistent solid-state memory (e.g., Flash memory, Magnetic RAM, etc.), or any other suitable storage media. As used herein, “computer-readable media” (also called “computer-readable storage media”) refers to tangible storage media. Tangible storage media are non-transitory and have at least one physical, structural component. In a “computer-readable medium,” as used herein, at least one physical, structural component has at least one physical property that may be altered in some way during a process of creating the medium with embedded information, a process of recording information thereon, or any other process of encoding the medium with information. For example, a magnetization state of a portion of a physical structure of a computer-readable medium may be altered during a recording process.

Embodiments have been described where the techniques are implemented in circuitry and/or computer-executable instructions. It should be appreciated that some embodiments may be in the form of a method or process, of which at least one example has been provided. The acts performed as part of the method or process may be ordered in any suitable way. Accordingly, embodiments may be constructed in which acts are performed in an order different than illustrated, which may include performing some acts simultaneously, even though shown as sequential acts in illustrative embodiments. Various aspects of the embodiments described above may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

It should be understood that aspects are described herein with reference to certain illustrative embodiments. The illustrative embodiments described herein are not necessarily intended to show all aspects, but rather are used to describe a few illustrative embodiments. Thus, aspects described herein are not intended to be construed narrowly in view of the illustrative embodiments. In addition, it should be understood that certain features disclosed herein might be used alone or in any suitable combination with other features.

### TECHNICAL EFFECTS

Embodiments described herein provide one or more technical effects and improvements to expediting dissemination of results of energy efficiency building evaluations, including for instance, carbon scores and energy data. For example, large volumes of energy audit data can be easily and quickly stored in the automated carbon model management system for access and use by multiple stakeholders, such as building owners, including homeowners, realtors, financial institutions, climate mitigation program managers, and government. Energy information can be quickly and digitally provided to many homeowners, enabling them to take upgrade action sooner in comparison to a manual onsite home evaluation.

Another technical effect includes each user of the system is authenticated and verified ensuring authenticity and traceability of system data. Carbon scores and energy data can be modified and tracked in the system as building upgrades are implemented and future energy audits are performed.

Another technical effect includes providing an auditable system that stores all carbon scores and energy data related to buildings. For example, all data stored in association with a building is saved and available to users.

Another technical effect includes providing a confidence score indicative of a confidence level of a carbon score. The confidence score gives to users, such as realtors, financial institutions, climate mitigation program managers, and government a level of trustworthiness of the carbon score and, in general, the accuracy of the data stored in the system.

What is claimed is:

1. A computer-implemented method of providing automated carbon model management, the method comprising at least a processor performing the steps of:
receiving first carbon-related data including first carbon score data indicative of a first carbon score and first energy data associated with a first building from a first user; and
based on authentication and validation of the first user,
storing the first carbon-related data in association with the first building in a first datastore, and
storing first user ID data indicative of the first user ID in association with the first carbon-related data in the first datastore.

2. The method of claim 1 wherein first carbon-related data includes first source data, first source data indicative of the source of the first carbon score data.

3. The method of claim 1 further comprising
based on the authentication and validation of the first user,
storing first date data indicative of a date the first carbon-related data is stored in the first datastore.

4. The method of claim 1 wherein first carbon-related data includes first building-related data associated with the first building.

5. The method of claim 1 further including
receiving a request from the first user for storing first carbon-related data in the first datastore.

6. The method of claim 1 wherein the first user includes one of a person and an application programming interface.

7. The method of claim 1 wherein receiving first carbon-related data includes converting the first carbon-related data into a predefined format for storing first carbon-related data in the first datastore in the predefined format.

8. The method of claim 1 wherein receiving first carbon-related data includes transforming the first carbon-related data for storing the first carbon-related data in the first datastore.

9. The method of claim 2 further including determining a first confidence score indicative of a first confidence level of the first carbon score based on the source data.

10. The method of claim 1 wherein the first datastore is at least one of a centralized database, cloud database, distributed database and distributed ledger.

11. The method of claim 1 further including
authenticating and validating a second user;
receiving a request from the second user to store second carbon-related data related to the first building in the first datastore;
receiving second carbon-related data from the second user including second carbon score data indicative of a second carbon score and second energy data associated with the first building; and
based on authentication and validation of the first user,
storing the first carbon-related data in a second datastore in association with the first building, the second datastore for storing audit data;
removing the first carbon-related data in the first datastore in association with the first building;
storing the second carbon-related data in the first datastore in association with the first building, and
storing second user ID data indicative of the second user ID in association with the second carbon-related data in the first datastore.

12. The method of claim 11 further including determining a second confidence score indicative of a second confidence level of the second carbon score based on source data and storing second confidence score data in association with the second carbon-related data in the first datastore.

13. The method of claim 11 further including
authenticating and validating a third user;
receiving a request from the third user for viewing data corresponding to the first building;
based on authentication and validation of the third user,
transmitting data stored in the first datastore corresponding to the first building to the third user.

14. The method of claim 13 including
authenticating and validating a fourth user;
receiving a request from the fourth user for viewing audit data corresponding to the first building; and
based on authentication and validation of the fourth user,
transmitting data stored in the second datastore corresponding to the first building to the fourth user.

15. The method of claim 1 further including registering the first user as a valid user and storing associated user ID data, role data, permission data and building ID data in a user datastore.

16. The method of claim 1 wherein receiving first carbon-related data including first carbon score data indicative of a first carbon score and first energy data associated with a first building from a first user includes,
receiving a plurality of first carbon-related data including a plurality of first carbon score data indicative of a plurality of first carbon scores and a plurality of first energy data associated with each of a plurality of first buildings from a first user; and
based on first permissions of the first user,
storing the first carbon-related data in association with the first building in a first datastore includes,
storing the plurality of first carbon-related data in association with the plurality of first buildings, and
storing first user ID data indicative of the first user ID in association with the first carbon-related data in the first datastore includes,
storing first user ID data indicative of the first user ID in association with the plurality of first carbon-related data in the first datastore.

17. An automated carbon model management system configured to
receive first carbon-related data including first carbon score data indicative of a first carbon score and first energy score associated with a first building from a first user; and
provided the first user is authenticated and validated,
store the first carbon-related data in association with the first building in a first datastore, and
store first user ID data indicative of the first user ID in association with the first carbon-related data in the first datastore.

18. The system of claim 17 further configured to
authenticate and validate a second user;
receive a request from the second user to store second carbon-related data related to the first building in the first datastore;
receive second carbon-related data from the second user including second carbon score data indicative of a second carbon score and second energy data associated with the first building; and
provided the second user is authenticated and validated,
store the first carbon-related data in a second datastore in association with the first building, the second datastore for storing audit data;
remove the first carbon-related data in the first datastore in association with the first building;
store the second carbon-related data in the first datastore in association with the first building, and
store second user ID data indicative of the second user ID in association with the second carbon-related data in the first datastore.

19. The system of claim 18 further configured to
authenticate and validate a third user;
receive a request from the third user for viewing data corresponding to the first building;
provided the third user is authenticated and validated,
transmit data stored in the first datastore corresponding to the first building to the third user.

20. The system of claim 18 further configured to
authenticate and validate a fourth user;
receive a request from the fourth user for viewing audit data corresponding to the first building; and
provided the fourth user is authenticated and validated,
transmit data stored in the second datastore corresponding to the first building to the fourth user.
